(19) United States
(12) Patent Application Publication
(10) Pub. No.: US 2013/0138637 A1
(43) Pub. Date: May 30, 2013

(54) SYSTEMS AND METHODS FOR RANKING MEDIA FILES

(71) Applicant: Walter Bachtiger, Novato, CA (US)

(72) Inventor: Walter Bachtiger, Novato, CA (US)

(21) Appl. No.: 13/751,107

(22) Filed: Jan. 27, 2013

Related U.S. Application Data
(63) Continuation-in-part of application No. 13/271,195, filed on Oct. 11, 2011.
Application No. 13/271,195 is a continuation-in-part of application No. 12/878,014, filed on Sep. 8, 2010.
(60) Provisional application No. 61/591,888, filed on Jan. 28, 2012.
(60) Provisional application No. 61/244,096, filed on Sep. 21, 2009.

(51) Int. Cl. G06F 17/30

(52) U.S. Cl. CPC G06F 17/30023
USPC 707/723

(57) ABSTRACT

A system for searching and ranking media files is disclosed, which includes a server that is configured to: (a) receive, index, and store a variety of media files, which are received by the server from a plurality of sources, within at least one database in communication with the server; and (b) receive at least one key word that is submitted by a user of the system through the website. The server will then query the database to identify all media files, which include at least one key word, and then ranks the media files in accordance with an algorithm. The algorithm produces a weighted ranking value, which reflects various attributes of each media file that is listed in a set of search results. The media files are then ranked in accordance with the calculated weighted ranking value.

### CROSS-REFERENCE TO RELATED APPLICATIONS

This application is a non-provisional application of provisional application Ser. No. 61/591,888, filed on Jan. 28, 2012, and is also a continuation-in-part of U.S. patent application Ser. No. 13/271,195, filed on Oct. 11, 2011, which is a continuation-in-part of U.S. patent application Ser. No. 12/878,014, filed on Sep. 8, 2010, which claims priority to U.S. provisional patent application Ser. No. 61/244,096, filed on Sep. 21, 2009.

### FIELD OF THE INVENTION

The field of the present invention relates to systems and methods for ranking a set of media files, which are identified from a search of a plurality of media files.

### BACKGROUND OF THE INVENTION

Systems for recording and storing media files have been available for many years and, indeed, are used by many individuals and businesses today. In addition, currently-available systems allow users to retrieve, either using a telephone or internet connection, media files that may be stored in a database and correlated with a specific user of the system. These types of systems have become a ubiquitous and important part of communication (and communication management) in today's world.

There are currently-available systems for searching and identifying a select number of media files from within a larger body of media files, i.e., so-called voice search functions. However, these currently-available systems are generally small scale, i.e., they are considerably limited in the number (and size) of media files that can be queried. For example, currently-available voice search systems are typically restricted in the number and types of media files that can be queried based on the number of speakers, length of such media files, total number of media files, and other factors. In addition, many of the currently-available systems have only basic methods for ranking and prioritizing a plurality of media files within a set of search results.

In view of the foregoing, there is an ongoing need for improved systems and methods that can be used to query and identify a select number of media files from within a larger body of media files. Preferably, such improved systems and methods will be more scalable, and capable of searching a larger body (or unlimited number) of media files compared to currently-available systems—and will be capable of searching media files of any length and involve any number of speakers. In addition, such improved systems and methods will preferably utilize various criteria (and combinations thereof) which have not previously been used to identify, prioritize, and rank voice content from within a plurality of media files.

As described further below, the present invention addresses many of these, and other, ongoing needs for improved systems and methods for searching for voice content from within a plurality of media files.

### SUMMARY OF THE INVENTION

According to certain aspects of the present invention, improved systems and methods for searching, identifying, and ranking a select number of media files from within a larger body of media files are provided. According to certain embodiments, the systems and methods employ the use of a particular algorithm, which is used to identify and rank a select number of media files (or portions thereof) from a larger body of media files. A non-limiting example of such algorithm is provided below:

rᵢ=aᵤ(x)+bᵥ(y)+cₓ(z)+d_{y}(w)

In the example above, “rᵢ” represents a weighted ranking value for media file “i,” with (x), (y), (z) and (w) corresponding to the criteria described below, and aᵤ, bᵥ, cₓ, and d_{y} representing constant weights to adjust the score for each measure. In the example above, (x) represents a measurement of key word frequency, key word density, linkage of a media file to other media files, or combinations thereof; (y) represents a measurement of speaker vocal emotion, length of listener playback, speaker charisma parameters, or combinations thereof; (z) represents a measurement of a relative proportion of multiple key words in a media file (i.e., a weighted term ranking), the presence of key words near the beginning and/or end of a media file (i.e., attention ranking), or combinations thereof; and (w) represents a measurement of the social activity that a particular media file has associated with it, such as a number of times that a media file has been shared with or referred to others (as described herein), the number and/or length of comments associated with a particular media file, a number of instances that a media file has been designated as a “favorite” by users of the system, the number of plays or views associated with a media file, or combinations of the foregoing.

According to the foregoing embodiment of the present invention, the larger the “rᵢ” value that is assigned to a particular media file (or portion thereof), the higher it will appear in a set of search results (i.e., the higher the ranking). As described further below, the media file ranking systems and methods of the present invention are preferably used in connection with, and incorporated into, a system that is configured to receive, index, and store a plurality of media files, such that the plurality of media files may then be queried and ranked using the methods and systems described herein, which will preferably utilize the algorithm set forth above and described in further detail below.

The above-mentioned and additional features of the present invention are further illustrated in the Detailed Description contained herein.

### BRIEF DESCRIPTION OF THE FIGURES

FIG. 1 is a diagram showing the different components of the systems described herein.

FIG. 2 is a diagram showing the interactive nature and media file sharing capability of the systems described herein.

FIG. 3 is a flow chart illustrating the controls provided by the systems described herein, which allow only specified users to access certain media files and/or comments related thereto within the centralized website.

FIG. 4 is a diagram showing certain non-limiting components of an exemplary graphical user interface in which a user may query the content of a plurality of media files, identify those media files which include a certain key word (or set of key words) that the user defines, and quickly view the context in which such key word is used in one or more media files.

FIG. 5 is a diagram that illustrates the means by which the systems and methods described herein allow users to query a large body of media files—and then playback excerpted and relevant portions thereof.

FIG. 6 is another diagram that illustrates the means by which the systems and methods described herein allow users to query a large body of media files, and then playback excerpted and relevant portions thereof using a media player.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

The present invention relates to systems and methods for ranking a set of media files, which are selected from a plurality of media files. The systems and methods of the present invention are preferably used in connection with, and incorporated into, a system that is configured to receive, index, and store a plurality of media files, such that the plurality of media files may then be queried and ranked using the methods and systems described herein. In order to place the ranking functionality of the present invention into proper context, the following will describe a non-limiting example of a system that is configured to receive, index, and store a plurality of media files, which may be used in connection with the media file ranking system of the present invention.

Media File Indexing, Storage, and Management System

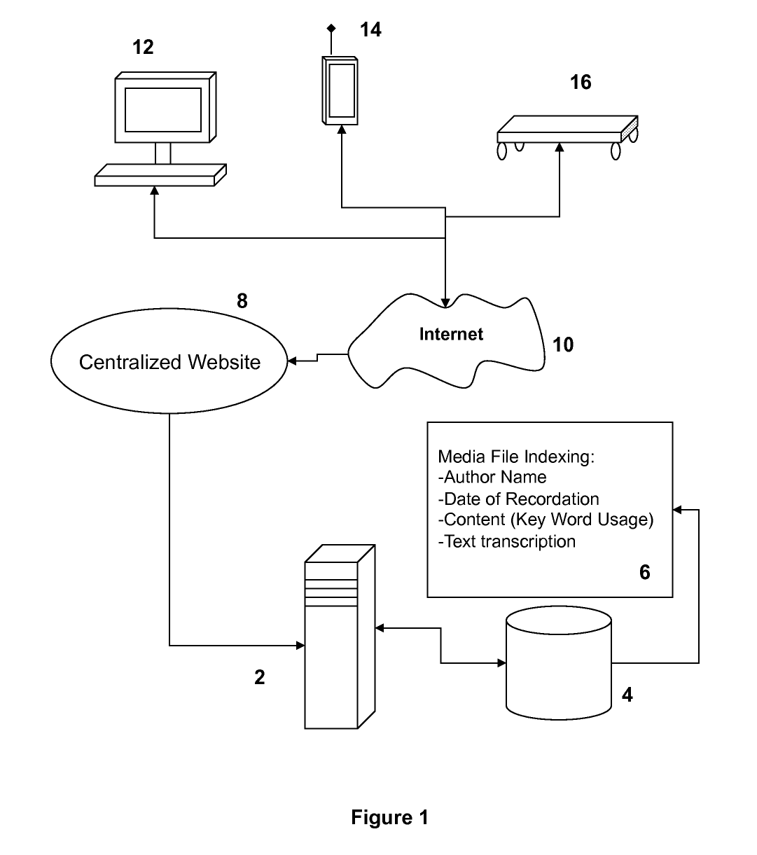

As used herein, the term “media file(s)” refers to audio files, video files, voice recordings, streamed media content, and combinations of the foregoing. Referring to FIG. 1, a media file indexing, storage, and management system will generally comprise a server 2 that is configured to receive, index, and store a plurality of media files, which are received by the server 2 from a plurality of sources, within at least one database 4 in communication with the server 2. The invention provides that the database 4 may reside within the server 2 or, alternatively, may exist outside of the server 4 while being in communication therewith via a network connection.

The media files may be indexed 6 and categorized within the database 4 based on author, time of recordation, geographical location of origin, IP addresses, language, key word usage, combinations of the foregoing, and other factors. The invention provides that the media files are preferably submitted to the server 2 through a centralized website 8 that may be accessed through a standard internet connection 10. The invention provides that the website 8 may be accessed, and the media files submitted to the server 2, using any device that is capable of establishing an internet connection 10, such as using a personal computer 12 (including tablet computers), telephone 14 (including smart phones, PDAs, and other similar devices), meeting conference speaker phones 16, and other devices. The invention provides that the media files may be created by such devices and then uploaded to the server 2 or, alternatively, the media files may be streamed in real time (through such devices) with the media files being created (and then indexed and stored) within the server 2 and database 4. In addition, as explained above, the invention provides that the media files that are stored within the server 2 and database 4 may be derived from audio-only content (e.g., a telephone conversation or talk radio) or, in certain cases, may comprise audio tracks derived from a video file (which has an audio component embedded therein).

The invention provides that the server 2 may receive and manage media files in many ways, such that the contents thereof may be deciphered and used as described herein. For example, as described further below, the invention provides that upon a media file being submitted to the server 2, the server 2 will perform a speech-to-text, speech-to-phoneme, speech-to-syllable, and/or speech-to-subword conversion, and then store an output of such conversion within the database 4. This way, the content of each media file may be intelligently queried (as described further below) and used in the manner described herein, such as for querying such content for key words.

The invention provides that when reference is made to “media files that contain a key word,” and similar phrases, it should be understood that such phrase encompasses a text file that contains the key word, with the text file being derived from a media file, as explained above. In other words, for example, after performing a speech-to-text conversion, and storing such text within the database 4, if a search is performed using the system of the present invention for media files that contain a particular key word, the system will actually search the converted text forms of such media files. Upon identifying any text forms of such media files that contain the queried key word, it will be inferred that the media file that corresponds with the searched text file will actually contain the key word.

The media files that are provided to the server 2 and database 4 may represent and be derived from, for example, a recorded telephone conversation, VoIP conversation, group meeting (through a speaker phone), speech or lecture (through a microphone), deposition or court room testimony (through a court reporter's microphone and/or transcript data entry), talk radio conversations, video content, and other audio sources. The invention provides that the systems described herein are preferably compatible with, and capable of receiving media files from, any devices that may be used among persons to communicate, to transmit communications, or to record communications.

When the present specification refers to the server 2, the invention provides that the server 2 may comprise a single server or a group of servers. In addition, the invention provides that the system may employ the use of cloud computing, whereby the server paradigm that is utilized to support the system of the present invention is scalable and may involve the use of different servers (and a variable number of servers) at any given time, depending on the number of individuals who are utilizing the system at different time points, which are in fluid communication with the database 4 described herein.

According to certain embodiments, the invention provides that a limited number of fields within the database 4 (which are associated with a particular media file) may be pre-filled by a media recording device. For example, the invention provides that the title and description fields (within the database 4) that are associated with a media file may be pre-filled with information that is sourced from the calendar entries stored within, for example, a mobile phone of the user that is submitting the media file (through the mobile phone) to the server 2 and database 4. For purposes of illustration, when the user submits a media file to the server 2 and database 4 through a mobile phone, the system will automatically query any calendar entries stored within the phone and transmit relevant information to the appropriate fields of a database 4 entry that is created for the media file, such as the media file title, the names of the persons who contributed to the content of the media file, date and time of recordation, and/or other relevant information. According to such embodiments, the automatically-filled data fields would be editable by the user, in order to make any necessary corrections thereto. The invention provides that similar functionality may be implemented using other recording means, such as internet-mediated communication portals (which may allow the system to automatically query emails and/or calendar programs stored within a personal computer).

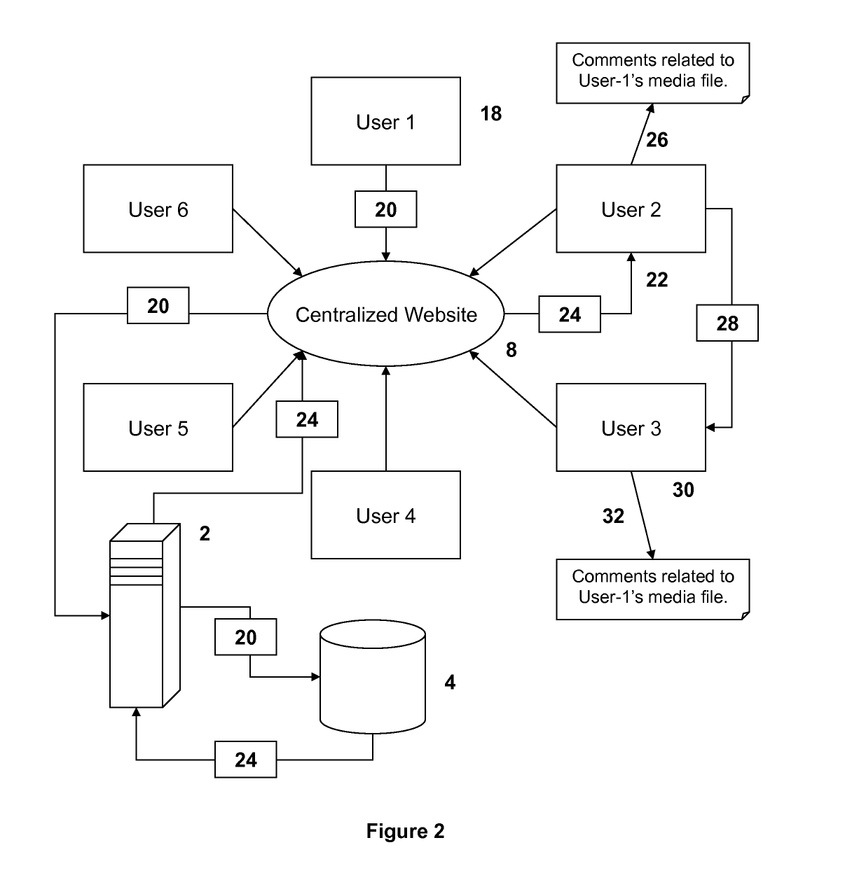

According to certain preferred embodiments, the invention provides that the server 2 is configured to make one or more of the media files accessible to persons other than the original source (or author) of the media files. The invention provides that the term “source” refers to a person who is responsible for uploading a media file to the server 2, whereas the term “author” refers to one or more persons who contributed content to an uploaded media file (who may, or may not, be the same person who uploads the media file to the server 2). For example, referring now to FIG. 2, a first user (User-1) 18 may submit 20 a media file to the server 2 through the centralized website 8, which is then indexed and stored within a database 4. The invention provides that if certain conditions are satisfied, as described below, the media files that the first user (User-1) 18 records within and uploads to the database 4 will then be accessible by other persons. For example, a second user (User-2) 22 may retrieve 24 and listen to User-1's media file from the database 4 through the centralized website 8.

Upon retrieving and accessing User-1's media file, User-2 22 may publish comments 26 regarding User-1's media files within a graphical user interface of the website 8. Moreover, User-2 22 may publish comments 26 regarding certain limited portions of User-1's media files, with the relative location of such comments being quickly ascertainable within the graphical user interface of the website 8. The invention provides that the comments 26 may be submitted to the server 2 through the website 8 by User-2 22, or any other persons who are granted access to User-1's 18 original media files. The invention provides that the comments 26 will be associated with User-1's 18 original media files within the database 4, along with other information collected by the server 2, such as the identity of the user/person submitting the comments 26, the date and time of submission, and/or other relevant information.

The invention further provides that the comments 26 may be viewed by any person accessing the website 8 or, alternatively, a limited group of persons who are granted access to User-1's 18 original media files. For example, an author of a media file, and/or the person (source) who submits a media file to the server 2, may submit instructions to the server 2 which only allow certain persons to access and listen to the media file. The invention provides that such access controls may be employed if a user (or author or source of a media file) does not want a media file to be generally available to all users of the system.

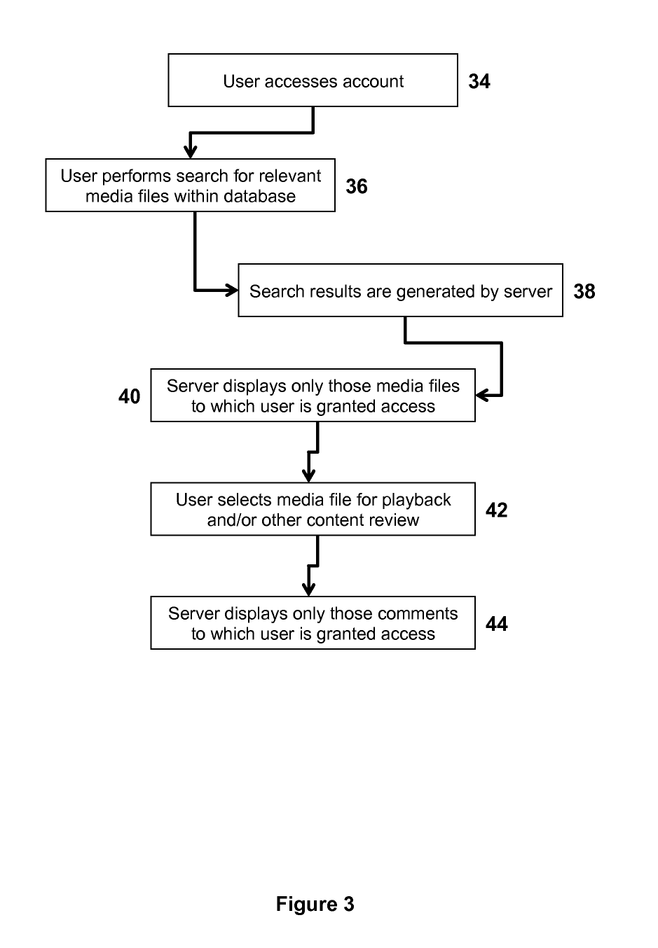

Referring to FIG. 3, and as described in further detail below, the invention provides that a user may access his/her account 34, by providing the server 2 with an authorized username/password through the centralized website 8. The user may then perform a search 36 of the database 4 for desired media files, namely, media files containing one or more search terms (key words), as described herein. The invention provides that the server 2 will then generate a list of results 38 (within the centralized website 8), using the ranking system and method described below. The user may then select one or more media files within the viewable search results for playback and/or other content review 42. In addition, upon selecting a media file from the search results within the centralized website 8, the server 2 will display only those comments (related to the selected media file) that the user is allowed to view 44. In other words, the individuals who publish comments regarding a media file may further limit access to such comments to only authorized users of the system.

Referring now to FIG. 2, according to certain preferred embodiments, the invention provides that a user of the system, such as User-2 22, may refer (or share) 28 a media file (with or without comments 26 associated therewith) to another user. When the other user, e.g., User-3 30, receives notice of such referral 28, the other user may access and listen to the referred media file and, optionally, publish comments 32 regarding User-1's media files within a graphical user interface of the website 8. In addition, the invention provides that users of the system may share, refer, and transmit to other users a limited portion of one or more media files. For example, if a first user determines that a second user may find a particular portion of a media file to be of interest, the first user may refer only the interesting portion of that media file to the second user. According to such embodiments, the invention provides that the graphical user interface of the website 8 may include certain controls which allow a user to excise portions of a media file and refer the same to another user, e.g., by using time coordinates associated with a media file, from beginning to end, to identify and refer only the relevant portion of a media file to another user of the system. The act of referring a media file, or an excerpted version thereof, may be carried out by sending, e.g., by e-mail, a hyperlink to another individual (with the hyperlink being associated with a place in the database 4 from which the media file, or an excerpted version thereof, may be retrieved).

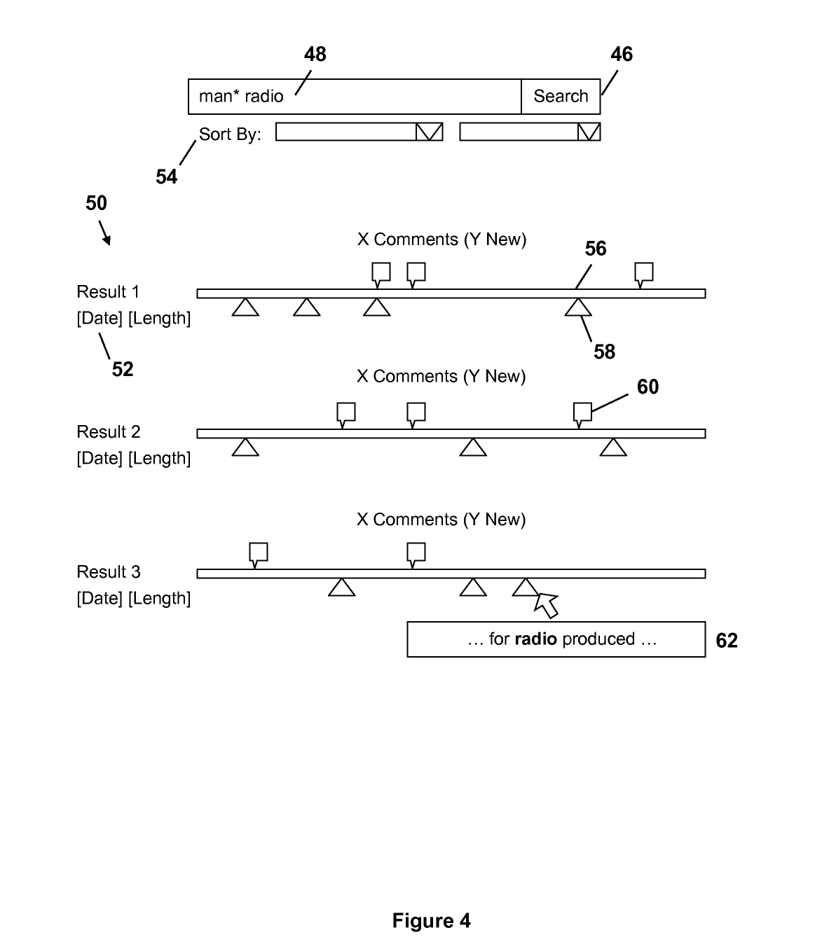

As mentioned above, according to certain preferred embodiments of the present invention, the system is configured to allow users to query the database 4, preferably through the website 8, for media files that include within the content thereof one or more key words. A non-limiting example of a portion of a graphical user interface showing an exemplary search function 46 is provided in FIG. 4. More particularly, the invention provides that the server 2 of the system may be configured to receive one or more key words 48 that are submitted by a user of the system through the website 8, whereupon the server 2 queries the database 4 to identify all media files which include the one or more key words 48. The invention provides that the system, and search function 46, may employ Boolean search logic, e.g., by allowing conjunctive and disjunctive searches, truncated and non-truncated forms of key words, exact match searches, and other forms of Boolean search logic.

The server 2 may then present the search results 50 to the user within the website 8 and, preferably, list all responsive media files in a defined order within such graphical user interface, with such order being dictated by the ranking system and methods described below. Still referring to FIG. 4, each media file included within a set of search results will preferably be graphically portrayed, such as in the form of a line 56 that begins at time equals zero (t=0) and ends at a point when the media file is terminated. For example, if the total length of a media file is five minutes, the left side of the line will be correlated with t=0 of the media file, whereas the right side of the line will be correlated with t=5 minutes of the media file. Still further, the invention provides that the location of each key word (search term) that was queried may be indicated along the line 56. For example, the location of each search term may be indicated with a triangle 58, or other suitable and readily visible element. The invention further provides that if multiple search terms were used in the search, the line 56 may be annotated with multiple triangles 58 (or other suitable elements), each of which may exhibit a different color that is correlated with a particular search term. More particularly, for example, if two search terms are used, the line 56 may be annotated with triangles 58 (or other suitable elements), which exhibit one of two colors, with one color representing a location of a first search term and a second color indicating the location of a second search term.

The invention further provides that each line 56 that represents a relevant media file may be annotated with one or more comments 60 posted by other users, as described herein. The invention provides that such annotation of the comments 60 will preferably indicate the location within the media file to which each comment 60 relates. According to yet further embodiments, the invention provides that when a user places a cursor (within the centralized website 8) over or in the near vicinity of a triangle 58 (or other element indicating the location of a search term) or a comment 60, the graphical user interface of the website 8 will automatically publish a temporary text box 62 in which the search term may be viewed, along with a limited number of words before and after the search term (i.e., the context in which the search term is used), which were transcribed by the system from the media file.

The invention provides that the text box 62 (which contains the transcribed text) will allow a user to quickly review the context in which the search term is used, which will facilitate knowing whether the media file (or a portion thereof) may be relevant to the user and worthy of playback and/or further review. According to certain embodiments, the invention provides that a user may, optionally, control the number of words appearing before and after the search term in the text box 62, by entering the desired number of words in a specified field within the user's dedicated account page. This way, each user may adjust the size of the text box 62 in accordance with his/her personal preferences.

In certain embodiments, the systems and methods of the present invention will only display text that has been transcribed from a media file, which satisfies a minimum accuracy confidence threshold. The invention provides that other non-literary symbols may be used to signify the presence of certain audio-to-text conversions that do not meet the predefined minimum accuracy confidence threshold. As mentioned above, a variety of algorithms may be employed during the transcription step, including, but not limited to, algorithms that may be used to perform speech-to-text, speech-to-phoneme, speech-to-syllable, and/or speech-to-subword conversions. In certain embodiments, Hidden Markov Model algorithms may be employed to execute the transcription. The methods further comprise calculating an accuracy confidence value, which will be a quantitative measure of the estimated accuracy of the transcription of a word derived from the media file (audio content) into written text.

The server 2 may then (or at anytime following insertion into the database 4) be instructed to display a set of results for such transcription 70 within the centralized website 8 (whether in the text box mentioned above or in other areas of the website 8), which may be viewed from a computing device 12,14,16. The invention provides, however, that such results will include transcribed words for only those words that meet or exceed a predefined accuracy confidence threshold. In other words, for each word that is transcribed from the media file, the associated accuracy confidence value for such word will be compared to the predefined accuracy confidence threshold. If the accuracy confidence value meets or exceeds the predefined accuracy confidence threshold, the transcribed word will be published within the set of results for such transcription.

As explained above, since the audio-to-text conversions may be viewed in the centralized website 8 (whether in text boxes associated with search terms or within other areas thereof), the website 8 may further include a set of controls and, particularly, a control that allows a user to quickly and easily adjust the predefined accuracy confidence threshold that is applied to a transcription (either before or after a transcription). For example, the invention provides that the website 8 may include a sliding control, which allows a user to adjust the predefined accuracy confidence threshold up and down, while simultaneously viewing the effect that such adjustment has on the number of words transcribed and the accuracy thereof.

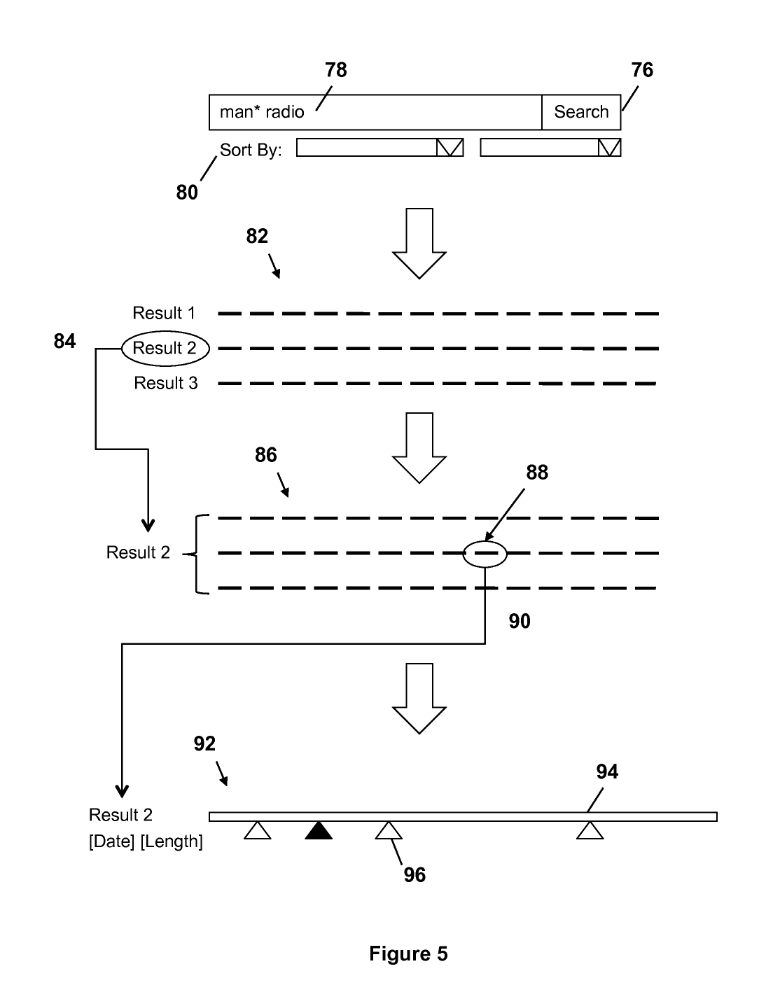

A second non-limiting example of a graphical user interface showing an exemplary search function 76 is provided in FIG. 5, which may be used to query excerpted portions of media files. More particularly, the invention provides that the server 2 of the system may be configured to receive one or more key words 78 that are submitted by a user of the system through the website 8, whereupon the server 2 queries the database 4 to identify all media files which include the one or more key words 78, and then ranks the identified media files using the ranking system and methods described herein. According to this embodiment, the audio track (audio content) that is streamed to the device will preferably begin at the location of the key word within the media file (or at a position located a pre-defined period of time prior to the first usage of the key word in the media file). The control may then be used to switch from one media file to another (e.g., down the list of search results), until a desirable media file is identified.

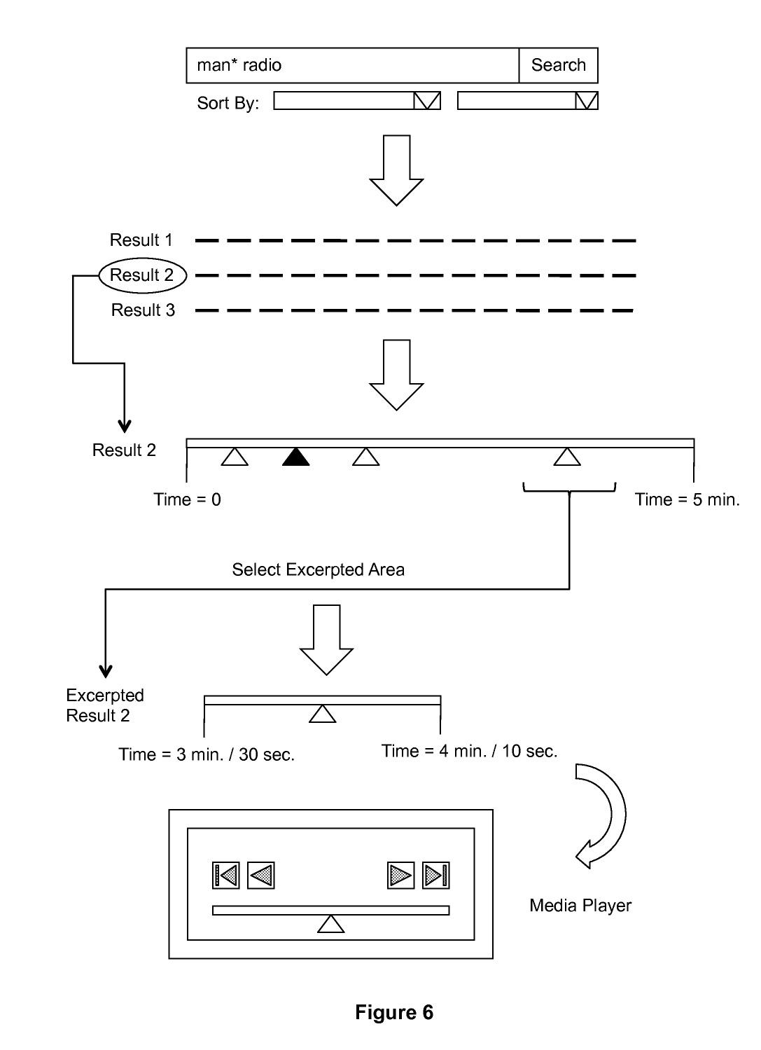

In such embodiments, the search results 82 will preferably consist of a list of media files that include the one or more key words. The server 2 will further provide a means for selecting 84 a media file within the search results, whereupon selecting a media file causes the server 2 to stream an audio track (audio content) to a device 12,14. The invention provides that the audio content will represent an excerpted portion of the media file that begins at (or at a predefined period of time prior to) a location of the queried key word in the audio track (audio content). In other words, referring to FIGS. 5 and 6, if a user selects a specific media file (e.g., a talk radio file) within a set of media files 82 that comprise a set of search results, the server 2 will cause a portion of the corresponding audio content to be streamed to the user's device 12,14. The audio content may begin at the exact location at which a key word is found within the audio content for the selected media file or, alternatively, at a predefined period of time prior to the location of the key word. In certain embodiments, for example, the predefined period of time, e.g., 5, 10, 15, 20, or more seconds, may be specified and adjusted by a user within the centralized website 8.

According to still further embodiments, the present invention provides that upon selecting 84 a media file within the search results 82, the server will publish a portion of the transcribed text 86 that surrounds the location of a key word 88. According to such embodiments, upon selecting 90 the key word 88 (or any other word included in the published text 86), the server 2 will cause a portion of the corresponding audio track (audio content) to be streamed to the user's device 12,14. Here again, the audio content may begin at the exact location at which the selected key word 88 is found within the media file or, alternatively, at a predefined period of time prior to the location of the key word 88.

Still referring to FIG. 5, and as described above relative to other embodiments, each media file that is selected and streamed to a user's device 12,14 may be graphically portrayed 92 within the graphical user interface of the centralized website 8. For example, the entire media file (or an excerpted portion thereof) may be portrayed in the form of a line 94 that begins at time equals zero (t=0) and ends at a point when the media file is terminated (or begins at a predefined period of time prior to the first use of a key word and ends at a predefined period of time following the last use of a key word). Still further, in certain preferred embodiments, the invention provides that the location of each key word that was queried may be indicated along the line 94. For example, the location of each search term may be indicated with a triangle 96, or other suitable and readily visible element. Still further, referring to FIG. 6, the invention provides that an entire media file, from beginning to end, may be graphically portrayed (as described above), as well as a selected excerpted portion thereof—and optionally played back and visualized within a media player.

Media File Ranking System

Referring now to FIG. 3, as mentioned above, the invention provides that a user may access his/her account 34, by providing the server 2 with an authorized username/password through the centralized website 8. The user may then perform a search 36 of the database 4 for desired media files, namely, media files containing one or more search terms (key words), as described herein. The invention provides that the server 2 will then generate a list of results 38, i.e., a list of media files that contain one or more of the queried search terms, within the centralized website 8. The user may then select one or more media files within the viewable search results for playback and/or other content review 42.

According to certain preferred embodiments, the invention provides certain improved systems and methods for searching, identifying, and ranking a select number of media files from within a larger body of media files. More particularly, the systems and methods employ the use of an algorithm, which is used to identify and rank a select number of media files (or excerpted portions thereof) from a larger body of media files. A non-limiting example of such algorithm is provided below:

rᵢ=aᵤ(x)+bᵥ(y)+cₓ(z)+d_{y}(w)

According to such embodiments, “rᵢ” represents a weighted ranking value for media file “i,” wherein the larger the “rᵢ” value that is assigned to a particular media file (or portion thereof), the higher it will appear in a set of search results (i.e., the higher the ranking).

In the algorithm set forth above, the variables (x), (y), (z) and (w) correspond to the criteria described below, and “aᵤ,” “bᵥ,” “cₓ,” and “d_{y}” represent constant weights to adjust the score for each measure. With respect to these variables, (x) represents a measurement of key word frequency, key word density, linkage of a media file to other media files, or combinations thereof; (y) represents a measurement of speaker vocal emotion, length of listener playback, speaker charisma parameters, or combinations thereof; (z) represents a measurement of a relative proportion of multiple search terms in a media file (i.e., a weighted term ranking), the presence of key words near the beginning and/or end of a media file (i.e., attention ranking), or combinations thereof; and (w) represents a measurement of the social activity that a particular media file has associated with it, such as a number of times that a media file has been shared with (referred to) others as described above, the number and/or length of comments (also described above) associated with a particular media file, a number of instances that a media file has been designated as a “favorite” by users of the system, the number of plays or views of a media file, or combinations of the foregoing.

More particularly, with respect to variable (x), the system may calculate the number of times that a searched key word is present in a particular media file or portion thereof (i.e., a key word frequency criterion). In addition, or as an alternative to a key word frequency criterion, variable (x) may represent a measure of keyword density, i.e., the number of times that a queried key word is detected within a defined portion of a media file (e.g., within a 10, 20, 30, 60, or 120 second segment of a media file). Still further, variable (x) may represent the number of times that a particular media file is linked to other media files, e.g., the number in-bound and/or out-bound hyperlinks that are associated with a particular media file and any other media file. According to yet further embodiments of the invention, variable (x) may represent a combination of the foregoing aspects of a particular media file.

With respect to variable (y), the system may represent a measurement of speaker charisma and/or vocal emotion. The measurement of speaker vocal emotion may take into account various acoustic parameters and profiles, which have been correlated with various emotions, such as anger, fear, joy, sadness, and neutral emotions. Those of ordinary skill in the art will recognize that certain emotions associated with high levels of physiological stimuli (e.g., anger, fear, anxiety, and joy) have been shown to be associated with increases in mean (average) F₀ values, more variable F₀ values, and vocal intensity. F₀ is known in the art as a metric that represents the fundamental frequency of speech, which corresponds to the rate of vocal-fold vibration and is perceived as vocal pitch. Acoustic differentiation among certain emotions have been found by examining F₀ contours (e.g., spectral patterns), or the pattern of F₀ changes over the course of a period of time. For example, F₀ has been found to decrease over time during experiences of anger, but to increase over time during portrayals of joy. In contrast, emotions associated with low levels of physiological arousal (e.g., sadness) have previously been correlated with lower mean F₀, F₀ variability, and vocal intensity, as well as decreases in F₀ over time.

Alternatively, or in addition to speaker vocal emotion, variable (y) may represent an average length of listener playback. This type of quantitative metric would be relevant insofar as it should correlate with an ability of a media file to capture and retain a listener's attention. For example, the server 2 may track and calculate a running mean for the duration of time that each user listens to a selected media file. This mean playback time may represent variable (y). Still further, as with the other variables, (y) may also represent a combination of the foregoing.

The invention provides that variable (z) may represent a measurement of a relative proportion of multiple key words in a media file (i.e., a weighted term ranking). For example, the invention provides that the system may allow a user to query a database of media files based on multiple key words. According to such embodiments, the variable (z) may represent a total sum of all key words found within each media file (or portions thereof). Alternatively, variable (z) may represent a total sum of all key words found within each media file (or portions thereof), multiplied by a weighting factor that is selected by the user. For example, in this embodiment, the user of the system may be allowed to specify that the presence of certain key words should be given more weight than others, during the ranking of corresponding media files in a set of search results. In addition, variable (z) may be an indicator for the presence of key words near the beginning and/or end of a media file (i.e., attention ranking). That is, the variable (z) may represent the total number of key words found within the first “β” number of seconds (or first β%) of a media file, and within the last “α” seconds (or last α%) of the media file. Still further, as with the other variables, variable (z) may represent a combination of the foregoing.

The invention further provides that variable (w) represents a measurement of the social activity that a particular media file has associated with it. For example, variable (w) may be correlated with the number of times that a media file has been shared with (referred to) others as described above. The system may track the total number of such referrals over a defined period of time, with such total representing variable (w). In addition, or alternatively, the system may track the total number of comments associated with a particular media file—or the total lines of commenting text, among all comments, associated with a media file (or, alternatively, a total word count among all comments associated with each media file). Still further, the invention provides that each media file may be linked to a social networking tag, whereby the system may allow users to select a linked tag associated with a particular media file to attribute some value to the media file, e.g., the system may track the total number of times that users select a “like” or “favorite” tag associated with each media file. In addition, or as an alternative, variable (w) may simply represent the number of times that a particular media file has been selected by a user for playback. And, similar to the other variables described above, (w) may represent a combination of the foregoing.

According to certain preferred embodiments, the invention provides that a user may specify the weights that should be applied to each of the variables (x), (y), (z) and (w), by adjusting the constant values that are assigned to “aᵤ,” “bᵥ,” “cₓ,” and “d_{y}.” According to certain preferred embodiments, the invention provides that such constant values may be adjusted by a user of the system, through the centralized website 8 described herein. This way, if a user of the system would like the search results to reflect a bias towards any of the variables (x), (y), (z) and (w), and less bias towards others, the user may adjust the corresponding constant values “aᵤ,” “bᵥ,” “cₓ,” and “d_{y}.”

### EXAMPLES

The following Examples are provided for illustration purposes only, and should not limit the scope of the claimed invention in any way.

### Example 1

### Variables with Single Definition

In the following example, (x), (y), (z) and (w) are defined as set forth in Table 1 below, and “aᵤ,” “bᵥ,” “cₓ,” and “d_{y}” are prescribed the constant weights set forth in Table 2 below.

TABLE 1

| Variable | Definitions |
|---|---|
| (x) | A measurement of key word frequency. |
| (y) | An average length of listener playback. |
| (z) | The total number of key words found within the first 10 |
| | seconds of a media file and within the last 10 seconds of |
| | the media file. |
| (w) | The total number of comments associated with a |
| | particular media file. |

TABLE 2

| Constant | Value |
|---|---|
| aᵤ | 0.4 |
| bᵥ | 0.3 |
| cₓ | 0.1 |
| d_{y} | 0.2 |

In this example, a user of the system conducted a search of the database as described herein, for media files that contain the key word “golf.” The search identified five different media files that include such key word, having the variable attributes identified in Table 3 below.

TABLE 3

| Media File | Variable Values |
|---|---|
| 1 | (x) = 3 hits |
| | (y) = 15 seconds |
| | (z) = 1 hit |
| | (w) = 5 comments |
| 2 | (x) = 5 hits |
| | (y) = 20 seconds |
| | (z) = 0 hit |
| | (w) = 2 comments |
| 3 | (x) = 2 hits |
| | (y) = 5 seconds |
| | (z) = 0 hit |
| | (w) = 1 comments |
| 4 | (x) = 3 hits |
| | (y) = 12 seconds |
| | (z) = 2 hit |
| | (w) = 4 comments |

Based on the foregoing data, the system calculates the “rᵢ” values using the algorithm set forth above (rᵢ=aᵤ(x)+bᵥ(y)+cₓ(z)+d_{y}(w)), as illustrated in Table 4 below.

TABLE 4

| Media File | rᵢ Values |
|---|---|
| 1 | rᵢ = (0.4)(3) + (0.3)(15) + (0.1)(1) + (0.2)(5) |
| | rᵢ = 6.8 |
| 2 | rᵢ = (0.4)(5) + (0.3)(20) + (0.1)(0) + (0.2)(2) |
| | rᵢ = 8.4 |
| 3 | rᵢ = (0.4)(2) + (0.3)(5) + (0.1)(0) + (0.2)(1) |
| | rᵢ = 2.5 |
| 4 | rᵢ = (0.4)(3) + (0.3)(12) + (0.1)(2) + (0.2)(4) |
| | rᵢ = 5.8 |

Based on the foregoing “rᵢ” values, the search results would be ranked as illustrated in Tables 5 and 6 below.

TABLE 5

| Media File | Ranking |
|---|---|
| 1 | #2 |
| 2 | #1 |
| 3 | #4 |
| 4 | #3 |

TABLE 6
Search Results

Media File 2
Media File 1
Media File 4
Media File 3

### Example 2

### Variables with Multiple Definitions

In the following example, variables (x), (y), (z) and (w) are defined as set forth in Table 7 below, and “aᵤ,” “bᵥ,” “cₓ,” and “d_{y}” are prescribed the constant weights set forth in Table 8 below.

TABLE 7

| Variable | Definitions |
|---|---|
| (x)₁ | A measurement of the key word frequency for “golf.” |
| (x)₂ | The number of times that the media file is linked to other |
| | media files. |
| (y)₁ | An average length of listener playback. |
| (y)₂ | Average F₀ value of a media file. |
| (z)₁ | The total number of key words found within the first 10 |
| | seconds of a media file and within the last 10 seconds of |
| | the media file. |
| (z)₂ | A total sum of the key word frequency for “golf” and |
| | “baseball.” |
| (w)₁ | The total number of comments associated with a |
| | particular media file. |
| (w)₂ | The total word count among all comments associated |
| | with a media file. |

TABLE 8

| Constant | Value |
|---|---|
| aᵤ | 0.3 |
| bᵥ | 0.3 |
| cₓ | 0.2 |
| d_{y} | 0.2 |

In this example, a user of the system conducted a search of the database as described herein, for media files that contain the key words “golf” and “baseball.” The search identifies five different media files that include such key words, having the variable attributes identified in Table 9 below.

TABLE 9

| Media File | Variable Values |
|---|---|
| 1 | (x)₁ = 3 hits |
| | (y)₁ = 15 seconds |
| | (z)₁ = 1 hit |
| | (w)₁ = 5 comments |
| | (x)₂ = 12 links |
| | (y)₂ = 2 (F₀ value) |
| | (z)₂ = 5 hits |
| | (w)₂ = 24 words |
| 2 | (x)₁ = 5 hits |
| | (y)₁ = 20 seconds |
| | (z)₁ = 0 hit |
| | (w)₁ = 2 comments |
| | (x)₂ = 2 links |
| | (y)₂ = 3 (F₀ value) |
| | (z)₂ = 6 hits |
| | (w)₂ = 9 words |
| 3 | (x)₁ = 2 hits |
| | (y)₁ = 5 seconds |
| | (z)₁ = 0 hit |
| | (w)₁ = 1 comments |
| | (x)₂ = 5 links |
| | (y)₂ = 4 (F₀ value) |
| | (z)₂ = 3 hits |
| | (w)₂ = 40 words |
| 4 | (x)₁ = 3 hits |
| | (y)₁ = 12 seconds |
| | (z)₁ = 2 hit |
| | (w)₁ = 4 comments |
| | (x)₂ = 2 links |
| | (y)₂ = 2 (F₀ value) |
| | (z)₂ = 5 hits |
| | (w)₂ = 10 words |

Based on the foregoing data, as with the previous Example, the system calculates the “rᵢ” values (Table 10) using the same algorithm as described above, provided that a mean value is calculated for each variable as illustrated in the modified algorithm below:

rᵢ=((aᵤ(x₁)+aᵤ(x₂))/2)+((bᵥ(y₁)+bᵥ(y₂))/2)+((cₓ(z₁)+cₓ(z₂))/2)+((d_{y}(w₁)+d_{y}(w₂))/2).

TABLE 10

| Media File | rᵢ Values |
|---|---|
| 1 | ((0.3)(3) + (0.3)(12))/2 + |
| | ((0.3)(15) + (0.3)(2))/2 + |
| | ((0.2)(1) + (0.2)(5))/2 + |
| | ((0.2)(5) + (0.2)(24))/2. |
| | rᵢ = 8.3 |
| 2 | ((0.3)(5) + (0.3)(2))/2 + |
| | ((0.3)(20) + (0.3)(3))/2 + |
| | ((0.2)(0) + (0.2)(6))/2 + |
| | ((0.2)(2) + (0.2)(9))/2. |
| | rᵢ = 6.2 |
| 3 | ((0.3)(2) + (0.3)(5))/2 + |
| | ((0.3)(5) + (0.3)(4))/2 + |
| | ((0.2)(0) + (0.2)(3))/2 + |
| | ((0.2)(1) + (0.2)(40))/2. |
| | rᵢ = 6.8 |
| 4 | ((0.3)(3) + (0.3)(2))/2 + |
| | ((0.3)(12) + (0.3)(2))/2 + |
| | ((0.2)(2) + (0.2)(5))/2 + |
| | ((0.2)(4) + (0.2)(10))/2. |
| | rᵢ = 5.0 |

Based on the foregoing “rᵢ” values, the search results would be ranked as illustrated in Tables 11 and 12 below.

TABLE 11

| Media File | Ranking |
|---|---|
| 1 | #1 |
| 2 | #3 |
| 3 | #2 |
| 4 | #4 |

TABLE 12
Search Results

Media File 1
Media File 3
Media File 2
Media File 4

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for searching and ranking media files, which comprises a server that is configured to:
(a) receive, index, and store a plurality of media files, which are received by the server from a plurality of sources, within at least one database in communication with the server; and
(b) receive at least one key word that is submitted by a user of the system through a website, whereupon the server queries the database to identify all media files which include the at least one key word and then ranks the media files which include the at least one key word according to an algorithm set forth below:
rᵢ=aᵤ(x)+bᵥ(y)+cₓ(z)+d_{y}(w),
wherein:
(i) rᵢ represents a weighted ranking value for a media file, wherein media files are ranked in accordance with said ranking values; (ii) aᵤ, bᵥ, cₓ, and d_{y} represent constant values; and (iii) variables (x), (y), (z) and (w) are defined as follows:
(x) represents a measurement of key word frequency, key word density, linkage of a media file to other media files, or combinations thereof;
(y) represents a measurement of speaker vocal emotion, length of listener playback, speaker charisma parameters, or combinations thereof;
(z) represents a measurement of a relative proportion of multiple key words in a media file, a number of key words within a defined period of time at a beginning and end of a media file, or combinations thereof; and
(w) represents a measurement of an amount of social activity that is associated with a media file.

2. The system for searching and ranking media files of claim 1, wherein the constant values represented by aᵤ, bᵥ, cₓ, and d_{y} may be defined by a user of the system.

3. The system for searching and ranking media files of claim 1, wherein the constant values represented by aᵤ, bᵥ, cₓ, and d_{y} are defined by the system.

4. The system for searching and ranking media files of claim 1, wherein the definition of variables (x), (y), (z) and (w) are adjustable by the user of the system.

5. The system for searching and ranking media files of claim 1, wherein the definition of variables (x), (y), (z) and (w) are not adjustable by the user of the system.

6. The system for searching and ranking media files of claim 1, wherein the measurement of an amount of social activity that is associated with a media file is defined by a number of times that a media file has been referred to others; a total number of comments associated with a media file; an average or aggregate length of comments associated with a media file; a number of instances that a media file is selected for playback by users; or combinations of the foregoing.

7. A system for searching and ranking media files, which comprises a server that is configured to:
(a) receive, index, and store a plurality of media files, which are received by the server from a plurality of sources, within at least one database in communication with the server;
(b) make each media file available for playback by users other than an original source of each such media file;
(c) receive and publish comments associated with the media files within a graphical user interface of a website, wherein the comments are submitted to the server through the website by persons other than the sources of such media files;
(d) receive at least one key word that is submitted by a user of the system through the website, whereupon the server queries the database to identify all media files which include the at least one key word; and
(e) rank the media files which include the at least one key word according to an algorithm set forth below:
rᵢ=aᵤ(x)+bᵥ(y)+cₓ(z)+d_{y}(w),
wherein:
(i) rᵢ represents a weighted ranking value for a media file, such that media files are ranked in accordance with said ranking values; (ii) aᵤ, bᵥ, cₓ, and d_{y} represent constant values; and (iii) variables (x), (y), (z) and (w) are defined as follows:
(x) represents a measurement of key word frequency, key word density, linkage of a media file to other media files, or combinations thereof;
(y) represents a measurement of speaker vocal emotion, length of listener playback, speaker charisma parameters, or combinations thereof;
(z) represents a measurement of a relative proportion of multiple key words in a media file, a number of keywords within a defined period of time at a beginning and end of a media file, or combinations thereof; and
(w) represents a measurement of an amount of social activity that is associated with a media file.

8. The system for searching and ranking media files of claim 7, wherein the constant values represented by aᵤ, bᵥ, cₓ, and d_{y} may be defined by a user of the system.

9. The system for searching and ranking media files of claim 7, wherein the constant values represented by aᵤ, bᵥ, cₓ, and d_{y} are defined by the system.

10. The system for searching and ranking media files of claim 7, wherein the definition of variables (x), (y), (z) and (w) are adjustable by the user of the system.

11. The system for searching and ranking media files of claim 7, wherein the definition of variables (x), (y), (z) and (w) are not adjustable by the user of the system.

12. The system for searching and ranking media files of claim 7, wherein the measurement of an amount of social activity that is associated with a media file is defined by a number of times that a media file has been referred to others; a total number of comments associated with a media file; an average or aggregate length of comments associated with a media file; a number of instances that a media file is selected for playback by users; or combinations of the foregoing.
